(19) United States
(12) Patent Application Publication
(10) Pub. No.: US 2025/0140793 A1
(43) Pub. Date: May 1, 2025

(54) POSITIVE ELECTRODE ACTIVE MATERIAL, BATTERY, AND METHOD OF MANUFACTURING POSITIVE ELECTRODE ACTIVE MATERIAL

(71) Applicant: TOYOTA JIDOSHA KABUSHIKI KAISHA, Toyota-shi (JP)

(72) Inventors: Ryosuke OHSAWA, Okazaki-shi (JP); Takahiko NINOMIYA, Miyoshi-shi (JP); Taku KINOSHITA, Toyota-shi (JP)

(73) Assignee: TOYOTA JIDOSHA KABUSHIKI KAISHA, Toyota-shi (JP)

(21) Appl. No.: 18/928,325

(22) Filed: Oct. 28, 2024

(30) Foreign Application Priority Data
Oct. 31, 2023 (JP) 2023-187164

(51) Int. Cl. H01M 4/36; C01G 53/00; H01M 4/48; H01M 4/525

(52) U.S. Cl. CPC H01M 4/364; C01G 53/50; H01M 4/483; H01M 4/525; C01P 2002/50; C01P 2004/82; C01P 2006/40

(57) ABSTRACT

A positive electrode active material contains particles of compound A having a composition represented by LiₓNiₐCo_{b}Mn_{c}O_{y}, and particles of compound B having a composition represented by M_{d}Oₑ, wherein, in the particles of compound B, an amount of an element having an ion radius α of 0.60 Å≤α≤1.38 Å is greater than or equal to 45 mol %, and surface area proportion X of the particles of compound B, with respect to a total of the particles of compound A and the particles of compound B, is 0.8%≤X≤19.6%. (Note that 0.1≤x≤1.5, 0.5≤a≤1.0, 0≤b≤0.3, 0≤c≤0.3, a+b+c=1.0, 1.5≤y≤2.1, 0.001≤d≤0.2 and 0.002≤e≤0.4, and M represents at least one element selected from the group consisting of Ti, Zr, Ta, Pr, K, La, Ba, Y, Sr, Ce, Se, Hf and Rh.)

### CROSS-REFERENCE TO RELATED APPLICATION

This application is based on and claims priority under 35 USC 119 from Japanese Patent Application No. 2023-187164 filed on Oct. 31, 2023, the disclosure of which is incorporated by reference herein.

### BACKGROUND

### Technical Field

The present disclosure relates to a positive electrode active material, a battery, and a method of manufacturing a positive electrode active material.

### Related Art

Conventionally, the addition of various added elements to positive electrode active materials that are used in batteries has been carried out for the purposes of improving the resistance characteristic of the battery and the like.

For example, Japanese Patent No. 6359323 discloses a surface-modified lithium-containing complex oxide used for the positive electrode of a lithium ion secondary battery, in which the surface of a lithium-containing complex oxide expressed by general formula (Liᵢ₊ₓ(Co_{(1-a-b-m)}NiₐAl_{b}Mₘ)₁₋ₓO_{2-(f/2)}F_{f}) is modified by a surface-modifying compound containing at least one element selected from the group consisting of group S1 and group S2 elements, wherein: group S1 is a group consisting of Al, Zr, Ti, Mg, Zn, Nb, Mo, Ta, W and rare earth elements; group S2 is a group consisting of F, P and S; M is at least one type of element selected from the group consisting of transition metals other than Co and Ni, and Sn, Ge, Na, K, B, C, Si, P, S, Zn, Ga, Bi, and alkaline earth metals and rare earth elements; and −0.05≤x≤0.05, 0≤a≤0.25, 0≤b≤0.05, 0≤m≤0.04 and 0≤f≤0.05.

Further, Japanese Patent No. 7300792 discloses a positive electrode active material for a lithium secondary battery including: a lithium-nickel-cobalt-manganese oxide expressed by chemical formula 1 (Liₐ[NiₓCo_{y}Mn_{z}]ₜM₁₋ₜO₂₋ₚXₚ) and containing secondary particles obtained by agglomerating at least one primary particle; and metal oxide particles disposed within the secondary particles and whose average particle diameter (D50) is a size at the nanometer level, wherein, in chemical formula 1, M is any one element selected from the group consisting of Al, Mg, Sn, Ca, Ge, Ga, B, Ti, Mo, Nb and W, and X is any one element selected from the group consisting of F, N and P, and a is 0.8≤a≤1.3, and 0.6≤x≤0.95, 0≤y≤0.2, 0≤z≤0.2, x+y+z=1, 0≤t≤1, 0≤p≤0.1.

### SUMMARY

In conventional positive electrode active materials, an added element (e.g., an element (element M) represented by M) is added to the positive electrode active material. Conventionally, this added element (element M) exists within the particles of the positive electrode active material as an Li compound obtained by reaction with the element Li. Element M that has reacted with the element Li tends to have high electron resistance. Therefore, a positive electrode active material that can further reduce battery resistance is desired.

The present disclosure was made in view of the above-described circumstances, and an object thereof is to provide a positive electrode active material that can realize low battery resistance when used in a battery, and a battery containing the positive electrode active material, and a method of manufacturing the positive electrode active material.

Means for addressing the above-described topic include the following aspects.

A positive electrode active material of a first aspect of the present disclosure containing particles of compound A having a composition represented by LiₓNiₐCo_{b}Mn_{c}O_{y}, and particles of compound B having a composition represented by M_{d}Oₑ, wherein:
in the particles of compound B, an amount of an element having an ion radius α of 0.60 Å≤α≤1.38 Å is greater than or equal to 45 mol %,
surface area proportion X of the particles of compound B, with respect to a total of the particles of compound A and the particles of compound B, is 0.8%≤X≤19.6%, and in the composition of compound A, 0.1≤x≤1.5, 0.5≤a≤1.0, 0≤b≤0.3, 0≤c≤0.3, a+b+c=1.0 and 1.5≤y≤2.1, and, in the composition of compound B, 0.001≤d≤0.2 and 0.002≤e≤0.4, and M represents at least one element selected from the group consisting of Ti, Zr, Ta, Pr, K, La, Ba, Y, Sr, Ce, Se, Hf and Rh.

The positive electrode active material of a second aspect according to the present disclosure is the positive electrode active material of the first aspect, wherein the element represented by M is at least one element selected from the group consisting of Ti, Zr, Ta, Pr, K and La.

The positive electrode active material of a third aspect according to the present disclosure is the positive electrode active material of the second aspect, wherein the element represented by M is Ti.

A battery of a fourth aspect according to the present disclosure including the positive electrode active material of any one of the first aspect to the third aspect.

A method of manufacturing a positive electrode active material of a fifth aspect according to the present disclosure, including:
a step of preparing a solution in which are dissolved raw materials containing Ni, Co and Mn, respectively;
a step of adding the solution into an alkaline solution, and precipitating a hydroxide;
a step of collecting a precipitate from the alkaline solution;
a step of mixing the precipitate, and a raw material that contains Li, and obtaining a first mixture;
a first firing step of firing the first mixture;
a step of mixing a raw material, which contains an element represented by M, with the first mixture that has undergone firing, and obtaining a second mixture; and
a second firing step of firing the second mixture,
wherein M represents at least one element selected from the group consisting of Ti, Zr, Ta, Pr, K, La, Ba, Y, Sr, Ce, Se, Hf and Rh.

In accordance with the present disclosure, there are provided a positive electrode active material that can realize low battery resistance when used in a battery, and a battery containing the positive electrode active material, and a method of manufacturing the positive electrode active material.

### BRIEF DESCRIPTION OF THE DRAWINGS

FIG. 1 is drawing illustrating the scheme of a method of manufacturing a positive electrode active material relating to an embodiment of the present disclosure.

### DETAILED DESCRIPTION

Embodiments that are examples of the present disclosure are described hereinafter. The description thereof and the Examples exemplify embodiments and do not limit the scope of the invention. In numerical value ranges that are expressed in a stepwise manner in the present specification, the maximum value or the minimum value listed in a given numerical value range may be substituted by the maximum value or the minimum value of another numerical value range that is expressed in a stepwise manner. Further, in the numerical value ranges put forth in the present specification, the maximum value or the minimum value of a given numerical value range may be substituted by a value set forth in the Examples.

Each component may contain plural types of the corresponding material. When listing the amounts of the respective components within a composition, in a case in which there are plural types of materials that correspond to a component within the composition, the amount of that component means the total amount of the plural types of materials existing within the composition, unless otherwise indicated.

“Step” is not only an independent step and includes steps that, even in a case in which that step cannot be clearly distinguished from another step, achieve the intended object of that step.

### <Positive Electrode Active Material>

A positive electrode active material relating to an embodiment of the present disclosure has compound A having a composition represented by LiₓNiₐCo_{b}Mn_{c}O_{y}, and compound B having a composition represented by M_{d}Oₑ.

In the particles of compound B, an amount of an element having an ion radius α of 0.60 Å≤a≤1.38 Å is greater than or equal to 45 mol %.

Further, surface area proportion X of the particles of compound B, with respect to the total of the particles of compound A and the particles of compound B, is 0.8%≤X≤19.6%.

(Note that, in the composition of compound A, 0.1≤x≤1.5, 0.5≤a≤1.0, 0≤b≤0.3, 0≤c≤0.3, a+b+c=1.0 and 1.5≤y≤2.1. Further, in the composition of compound B, 0.001≤d≤0.2 and 0.002≤e≤0.4, and M represents at least one element selected from the group consisting of Ti, Zr, Ta, Pr, K, La, Ba, Y, Sr, Ce, Se, Hf and Rh.

Note that ratio x of the Li element, ratio a of the Ni element, ratio b of the Co element, ratio c of the Mn element and ratio y of the O element that are contained in compound A, and ratio d of element M and ratio e of the O element that are contained in compound B, are ratios in the total of the particles of compound A and the particles of compound B. Namely, ratios x, a, b, c and y are not ratios in only compound A, and are the ratios in the total of compound A and compound B. Further, ratios d and e are not ratios in only compound B, and are the ratios in the total of compound A and compound B.

Conventionally, added elements (i.e., elements represented by M, also called “element M” hereinafter) have been added to positive electrode active materials for the purposes of improving the resistance characteristic of batteries, and the like. Note that, conventionally, the added element (element M) exists within the particles of the positive electrode active material as an Li compound obtained by reaction with the element Li. However, element M that has reacted with the element Li tends to have high electron resistance, and further improvement is desired from the standpoint of reducing the battery resistance at the time when this positive electrode active material is used in batteries.

To address this, the positive electrode active material relating to the embodiment of the present disclosure contains two types of particles that are active material particles (i.e., particles of compound A) and particles containing an oxide (M_{d}Oₑ) of element M (i.e., particles of compound B).

Note that, in the particles of compound B, the amount of an element having an ion radius α of 0.60 Å≤a≤1.38 Å, is greater than or equal to 45 mol %. In other words, this means that the element Ti, Zr, Ta, Pr, K, La, Ba, Y, Sr, Ce, Se, Hf, and/or Rh is sufficiently contained within the particles of compound B.
Further, the surface area proportion X being in the range of 0.8%≤X≤19.6% means that element M that has not reacted with the Li element (i.e., element M that is contained in compound B) sufficiently exists within the positive electrode active material.
Due thereto, element M, which has not reacted with the Li element, and has low electron resistance, exists sufficiently between the particles of the positive electrode active material, and therefore, the battery resistance can be reduced.

Details of the positive electrode active material relating to the embodiment of the present disclosure are described next.

### (Particles of Compound A)

The positive electrode active material relating to the embodiment of the present disclosure has particles of compound A that has the composition represented by LiₓNiₐCo_{b}Mn_{c}O_{y}.
Note that the particles of compound A are the particles that contain the positive electrode active material.
(In the composition of compound A, 0.1≤x≤1.5, 0.5≤a≤1.0, 0≤b≤0.3, 0≤c≤0.3, a+b+c=1.0 and 1.5≤y≤2.1.)

In the composition of the particles of compound A, from the standpoints of the resistance characteristic of the battery and the like, ratio x of the Li is 0.1 or more and 1.5 or less, and is preferably 0.3 or more and 1.4 or less, and is more preferably 0.5 or more and 1.2 or less.

Ratio a of the Ni is 0.5 or more and 1.0 or less, and is preferably 0.6 or more and 0.9 or less, and is more preferably 0.7 or more and 0.8 or less.
Ratio b of the Co is 0 or more and 0.3 or less, and is preferably 0 or more and 0.2 or less, and is more preferably 0.1 or more and 0.2 or less.
Ratio c of the Mn is 0 or more and 0.3 or less, and is preferably 0 or more and 0.2 or less, and is more preferably 0.1 or more and 0.2 or less.
Note that the total (a+b+c) of the ratios of the Ni, Co and Mn is 1.0.
Ratio y of the O is 1.5 or more and 2.1 or less, and is preferably 1.7 or more and 2.1 or less, and is more preferably 1.9 or more and 2.0 or less.
Note that, as described above, the ratios x, a, b, c and y in compound A are ratios in the total of the particles of compound A and the particles of compound B.

### (Particles of Compound B)

The positive electrode active material relating to the embodiment of the present disclosure has particles of compound B that has the composition represented by M_{d}Oₑ.
(In the composition of compound B, 0.001≤d≤0.2 and 0.002≤e≤0.4. M represents at least one element selected from the group consisting of Ti, Zr, Ta, Pr, K, La, Ba, Y, Sr, Ce, Se, Hf and Rh.)

Compound B contains, as the added element (element M), at least one element selected from the group consisting of Ti, Zr, Ta, Pr, K, La, Ba, Y, Sr, Ce, Se, Hf and Rh.

Due to an element that is exemplified above as the added element being contained in the particles of compound B as an oxide, when the positive electrode active material is used in a battery, the battery resistance can be reduced.
Note that, from the standpoint of reducing the battery resistance, compound B preferably contains, as the added element (element M), at least one element selected from the group consisting of Ti, Zr, Ta, Pr, K and La, and more preferably contains Ti.

In the composition of the particles of compound B, from the standpoints of the resistance characteristic of the battery and the like, ratio d of M is 0.001 or more and 0.2 or less, and is preferably 0.01 or more and 0.15 or less, and is more preferably 0.05 or more and 0.1 or less.

Ratio e of the O is 0.002 or more and 0.4 or less, and is preferably 0.01 or more and 0.3 or less, and is more preferably 0.03 or more and 0.2 or less.
Note that, as described above, the ratios d and e in compound B are ratios in the total of the particles of compound A and the particles of compound B.

In the particles of compound B, the amount of an element having an ion radius α of 0.60 Å≤α≤1.38 Å (hereinafter also called “specific element”) is greater than or equal to 45 mol %. Here, Ti, Zr, Ta, Pr, K, La, Ba, Y, Sr, Ce, Se, Hf and Rh, which are the above-described added element (element M), are included among elements (the specific elements) whose ion radius α is 0.60 Å≤α≤1.38 Å. Namely, the amount of the specific element in the particles of compound B is an index of the amount of element M that is contained in the particles of compound B.

The amount of an element having an ion radius α of 0.60 Å≤α≤1.38 Å (the specific element), in the particles of compound B is greater than or equal to 45 mol %, and, from the standpoints of the resistance characteristic of a battery and the like, is preferably greater than or equal to 50 mol % and less than or equal to 90 mol %, and is more preferably greater than or equal to 55 mol % and less than or equal to 87 mol %.

### (Surface Area Proportion X of Particles of Compound B)

In the positive electrode active material relating to the embodiment of the present disclosure, surface area proportion X of the particles of compound B, with respect to the total of the particles of compound A and the particles of compound B, is 0.8%≤X≤19.6%. Due to the surface area proportion X being greater than or equal to 0.8%, element M that has not reacted with the Li element (i.e., element M that is contained in the particles of compound B) sufficiently exists within the positive electrode active material, and the battery resistance can be reduced. On the other hand, due to the surface area proportion X being less than or equal to 19.6%, the particles of compound A (i.e., the particles containing the positive electrode active material) exist sufficiently, and the function of a positive electrode can be exhibited sufficiently.
From the standpoint of the resistance characteristic of the battery and from the standpoint of the function of a positive electrode, the surface area proportion X of the particles of compound B is preferably 2.0%≤X≤15.0%, and is more preferably 4.0%≤X≤10.0%.

### [Measuring of Amount of Specific Element and Surface Area Proportion X of Particles of Compound B]

The amount of an element (specific element) having an ion radius α of 0.60 Å≤α≤1.38 Å in the particles of compound B, and the surface area proportion X of the particles of compound B with respect to the total of the particles of compound A and the particles of compound B, are measured by the following methods.
First, data is acquired by a scanning electron microscope (SEM) such that 10 particles of the positive electrode active material that is the subject of measurement are included therein, and this is repeated until data of 100 particles can be acquired. Next, by quantitative analysis of the composition by energy-dispersive X-ray spectroscopy (EDX), a circular analysis region that runs along the outer periphery of each particle is set and acquired.
The amount of the element (the specific element) having an ion radius α of 0.60 Å≤α≤1.38 Å in the particles of compound B is determined by the EDX quantitative analysis of the composition.
Further, the surface area proportion (surface area %) of the particles (i.e., the particles of compound B), at which the amount of the element having an ion radius of 0.60 Å˜1.38 Å (the specific element) is greater than or equal to 45 mol %, is derived from the data of the circular analysis regions that are set along the outer peripheries of the respective particles.

### <Method of Manufacturing Positive Electrode Active Material>

A method of manufacturing a positive electrode active material relating to an embodiment of the present disclosure is described next. Note that the above-described positive electrode active material relating to an embodiment of the present disclosure can be manufactured by the method of manufacturing a positive electrode active material that relates to an embodiment of the present disclosure and is described hereinafter.

The method of manufacturing a positive electrode active material relating to the embodiment of the present disclosure has following steps (1)˜(7):
(1) a step of preparing a solution in which are dissolved raw materials containing Ni, Co and Mn, respectively (dissolving of raw materials);
(2) a step of adding the solution into an alkaline solution, and precipitating a hydroxide (crystallizing);
(3) a step of collecting the precipitate from the alkaline solution;
(4) a step of mixing the precipitate, and a raw material that contains Li, and obtaining a first mixture (addition of Li raw material);
(5) a first firing step of firing the first mixture (first firing);
(6) a step of mixing a raw material, which contains an element represented by M, with the first mixture that has undergone firing, and obtaining a second mixture (addition of M raw material); and
(7) a second firing step of firing the second mixture (second firing).
   (Note that M represents at least one element selected from the group consisting of Ti, Zr, Ta, Pr, K, La, Ba, Y, Sr, Ce, Se, Hf and Rh.)

In the method of manufacturing a positive electrode active material relating to the embodiment of the present disclosure, after the raw material containing Li is added and the first firing is carried out, the raw material containing an element represented by M is added and the second firing is carried out. Element M can exist as an oxide (i.e., the particles of compound B) without becoming an Li compound, and a positive electrode active material having low resistance can be obtained.

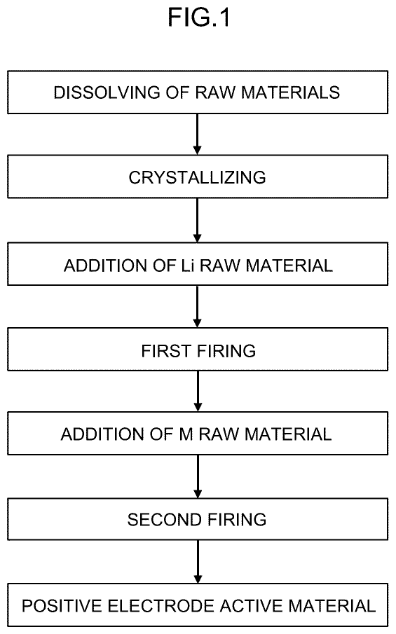

These respective steps are described hereinafter in accordance with the scheme illustrated in FIG. 1.

(1) Step of Preparing a Solution in which are Dissolved Raw Materials Containing Ni, Co and Mn, Respectively
A solution, in which are dissolved a raw material containing Ni, a raw material containing Co and a raw material containing Mn, is prepared (the “dissolving of raw materials” step shown in FIG. 1).
For example, the solution can be prepared by dissolving, in a solvent such as water or the like, a raw material containing Ni, a raw material containing Co and a raw material containing Mn.
The concentration of the solution is preferably made to be in the range of 10˜40 mass % for example. The ratio of the Ni/Co/Mn, with respect to Ni:1.0, is preferably made to be a ratio of 1.0/0.8˜1.2/0.8˜1.2 (atm %).

Sulfates such as NiSO₄ and the like are examples of the raw material containing Ni. Sulfates such as CoSO₄ and the like are examples of the raw material containing Co. Sulfates such as MnSO₄ and the like are examples of the raw material containing Mn.

(2) Step of Adding the Solution into an Alkaline Solution, and Precipitating a Hydroxide
Next, the solution is added into an alkaline solution, and a hydroxide is precipitated (the “crystallizing” step shown in FIG. 1). Due thereto, particles, at which a hydroxide containing Ni, Co, and Mn is generated, crystallize, and these particles are obtained as a precipitate. In this step, for example, a hydroxide of transition metals precipitates by adding the solution and NH₃ in drops while controlling the alkaline solution, in which the hydroxide has precipitated, to be a pH of a constant level (e.g., a pH of 10˜12).
(3) Step of Collecting the Precipitate from the Alkaline Solution
Next, the precipitate is collected from the alkaline solution.
A method of filtering and rinsing is an example of the method of collecting the particles of the precipitate. An example is a method in which, first, the precipitate (particles) are removed by filtering and are rinsed, and then the liquid used in the rinsing is filtered, and the precipitate (particles) are removed. Note that the precipitate (particles) after the rinsing may further be dried.
(4) Step of Mixing the Precipitate, and a Raw Material that Contains Li, and Obtaining a First Mixture
Next, the collected precipitate (particles), and a raw material that contains Li, are mixed together, and a first mixture is obtained (the “addition of Li raw material” step shown in FIG. 1). For example, the particles of the collected precipitate, and a raw material containing Li, can be mixed together in a mortar.
Examples of the raw material that contains Li are Li₂CO₃, LiOH and the like.

### (5) First Firing Step of Firing the First Mixture

Next, the first mixture of the collected precipitate (particles) and the raw material that contains Li is fired (the “first firing” step shown in FIG. 1). For example, the first mixture can be fired in a firing furnace (a muffle furnace or the like). The conditions for the firing can be made to be, for example, a temperature of 800° C.˜1100° C., an oxygen atmosphere, a time of 5 hours ˜20 hours, or the like.

Note that crushing of the first mixture that has undergone the first firing may be carried out in order to make the first mixture have a predetermined particle diameter. A method of crushing by a mill (e.g., a jet mill), or the like is an example of the method of crushing.

(6) Step of Mixing a Raw Material, which Contains an Element Represented by M, with the First Mixture that has Undergone Firing, and Obtaining a Second Mixture
Next, the first mixture that has undergone the first firing, and a raw material containing an element represented by M, are mixed together, and a second mixture is obtained (the “addition of M raw material” step shown in FIG. 1). For example, the first mixture that has undergone the first firing and the raw material containing M can be mixed together in a mortar.
Examples of raw materials containing M (i.e., at least one element selected from the group consisting of Ti, Zr, Ta, Pr, K, La, Ba, Y, Sr, Ce, Se, Hf and Rh) are oxides of these respective elements (e.g., TiO₂, ZrO₂, Ta₂O₅, Pr₂O₃, La₂O₃ and K₂O), and the like.

### (7) Second Firing Step of Firing the Second Mixture

Next, the second mixture, which contains a raw material containing an element represented by M, is fired (the “second firing” step shown in FIG. 1). For example, the second mixture can be fired in a firing furnace (a muffle furnace or the like). The conditions for the firing can be made to be, for example, a temperature of 400° C.˜600° C., an oxygen atmosphere, a time of 5 hours ˜20 hours, or the like. The firing temperature in the second firing step is preferably a temperature that is lower than the firing temperature in the first firing step.

Note that crushing of the second mixture that has undergone the second firing may be carried out in order to make the second mixture have a predetermined particle diameter. A method of crushing by a mill (e.g., a jet mill), or the like is an example of the method of crushing.

The positive electrode active material relating to the present disclosure that has particles of compound A and particles of compound B can be obtained through these steps.

### <Battery>

A battery relating to an embodiment of the present disclosure contains the positive electrode active material relating to the embodiment of the present disclosure. The battery has, for example, a negative electrode, a positive electrode, a separator, and an electrolyte.
The battery relating to the embodiment of the present disclosure is preferably a liquid battery containing an electrolyte liquid that is a liquid, but may be a solid-state battery containing a solid electrolyte. Further, the battery may be a bipolar battery having a positive electrode active material layer and a negative electrode active material layer on the both surfaces of a collector that has the functions of a positive electrode collector and a negative electrode collector.

### (Positive Electrode)

The positive electrode has, for example, a positive electrode collector, and a positive electrode active material layer fixed on the positive electrode collector.
The positive electrode active material layer has, as the positive electrode active material thereof, the positive electrode active material relating to the embodiment of the present disclosure. Details of the positive electrode active material have been described above, and are therefore omitted here.
The positive electrode active material layer may, in addition to the positive electrode active material, contain a conductive material, and may further contain other components such as, for example, a binder, various additives, or the like. Examples of the conductive material are carbon that is hard to graphitize, acetylene black, carbon that is easy to graphitize such as carbon black and the like, graphite, and the like. Examples of the binder are vinyl halide resins such as polyvinylidene fluoride (PVdF) and the like.

A conductive member formed from a metal having good conductivity (e.g., aluminum) is suitable as the positive electrode collector. Note that the positive electrode collector may be a collector having the functions of a positive electrode collector and a negative electrode collector (i.e., a bipolar battery).

### (Negative Electrode)

The negative electrode has, for example, a negative electrode collector, and a negative electrode active material layer fixed on the negative electrode collector. A conductive member formed from a metal having good conductivity (e.g., copper) is suitable as the negative electrode collector. Note that the negative electrode collector may be a collector (i.e., a bipolar battery) having the functions of a positive electrode collector and a negative electrode collector.
The negative electrode active material layer contains a negative electrode active material. Graphite-based carbons such as natural graphite, artificial graphite, amorphous coated graphite and the like are examples of the negative electrode active material. The proportion of graphite contained in the graphite-based carbon is greater than or equal to approximately 50 mass %, and preferably greater than or equal to 80 mass %. The negative electrode active material layer may be structured from only a negative electrode active material, or, as needed, may contain components other than a negative electrode active material such as a thickener, a binder or the like. Examples of the thickener are celluloses such as carboxymethylcellulose (CMC) and the like. Examples of the binder are rubbers such as styrene-butadiene copolymer (SBR) and the like, and vinyl halide resins such as polyvinylidene fluoride (PVdF) and the like.

### (Separator)

The separator is an electrically insulating, porous film. The separator electrically isolates the positive electrode and the negative electrode. The separator may have a thickness of 5 30 μm for example. The separator can be structured by, for example, a porous polyethylene (PE) film, a porous polypropylene (PP) film, or the like. The separator may be a multilayer structure. For example, the separator may be structured by a porous PP film, a porous PE film and a porous PP film being layered in that order. The separator may have a heat-resistant layer on the surface thereof. The heat-resistant layer contains a heat-resisting material. Examples of the heat-resisting material are metal oxide particles such as alumina or the like, high melting point resins such as polyimide or the like, and the like.

### (Electrolyte Liquid)

The battery relating to the embodiment of the present disclosure may be a liquid battery that further contains an electrolyte liquid. In particular, a non-aqueous electrolyte liquid is preferable.

### Solvent

The non-aqueous electrolyte liquid contains a solvent (a non-aqueous solvent) and an electrolyte.
Examples of the solvent (non-aqueous solvent) are ethyl carbonate (EC), dimethyl carbonate (DMC), ethyl methyl carbonate (EMC), propylene carbonate (PC), fluoroethylene carbonate (FEC), N,N-diethyl-N-methyl-N-(2-methoxyethyl)ammonium bis(fluorosulfonyl)imide (DEME), 1-ethyl-3-methylimidazolium bis(fluorosulfonyl)imide (EMI), 1-ethyl-2,3-dimethylimidazolium bis(fluorosulfonyl)imide (DEMI-FSI), and the like.

### Electrolyte

Lithium salts are examples of the electrolyte in the electrolyte liquid. Examples of lithium salts are lithium bis(fluorosulfonyl)imide (LiFSI), LiPF₆ (lithium hexafluorophosphate), lithium tetrafluoroborate (LiBF₄), Li[N(CF₃SO₂)₂], and the like.
The amount of the electrolyte may be, for example, 1.0˜2.0 mol/L, and is preferably 1.0˜1.5 mol/L.

In addition to the solvent and the electrolyte, the electrolyte liquid may contain various additives such as, for example, thickeners, film-forming agents, gas generating agents, and the like. The electrolyte is typically a non-aqueous electrolyte liquid that is in a liquid state at ordinary temperatures (e.g., 25±10° C.). The electrolyte liquid typically assumes a liquid state in usage environments of batteries (e.g., environments of temperatures of −20˜+60° C.).

### Applications

Examples of applications of the battery are the power source of a hybrid vehicle (HEV), a plug-in hybrid vehicle (PHEV), an electric vehicle (BEV) or the like.

### EXAMPLES

The present disclosure is described hereinafter on the basis of Examples, but the present disclosure is not in any way limited to these Examples.

### Example 1

### (Synthesizing of Positive Electrode Active Material)

A positive electrode active material having particles of compound A, which had a composition represented by LiₓNiₐCo_{b}Mn_{c}O_{y} and in which x, a, b, c and y were in the ratio listed in Table 1, and particles of compound B, which had a composition represented by M_{d}Oₑ and in which d and e were in the ratio listed in Table 1 and in which the element listed in Table 1 was used as the element represented by M, was synthesized by the method described hereinafter.

### Raw Material Solution

NiSO₄, CoSO₄ and MnSO₄ were dissolved in ion-exchanged water, and a raw material solution was obtained. The ratio of the Ni/Co/Mn was 1/1/1 (atm %), and the concentration of the aqueous solution was made to be 30 mass %.

### Crystallization

A given amount of an NH₃ aqueous solution was placed in a reaction vessel, and nitrogen substitution was carried out while stirring by a stirrer. NaOH was added into the reaction vessel, and the pH was made alkaline. Next, the raw material solution and NH₃ were added in drops while controlling the reaction vessel interior to a constant pH (a pH of 10˜12), and a transition metal hydroxide was precipitated.

### Rinsing, Filtering, Drying

The precipitated transition metal hydroxide was removed by filtering. Ion-exchanged water was added thereto and dispersed by stirring by a spoon, so as to carry out rinsing.
Next, the liquid used in the rinsing was filtered, and the transition metal hydroxide was removed.
Then, the filtered-out transition metal hydroxide was dried for 16 hours at 120° C., and the moisture was evaporated.

### Mixing of Li Raw Materials

The dried transition metal hydroxide, and Li₂CO₃ and LiOH serving as Li raw materials, were mixed together in a mortar.

### Firing 1 and Crushing 1

The mixture of the transition metal hydroxide and the Li raw materials was fired for 10 hours in a firing furnace (muffle furnace) at 800° C. in an oxygen atmosphere (firing 1). Then, by crushing the mixture, which had undergone the firing, in a mill (a jet mill), the mixture was crushed to a predetermined particle diameter (crushing 1).

### Mixing of M Raw Material

TiO₂ serving as an M raw material was mixed together with the crushed mixture in a mortar.

### Firing 2 and Crushing 2

The mixture of the pulverized mixture and the M raw material (TiO₂) was fired for 10 hours in a firing furnace (muffle furnace) at 400° C. (firing 2). Then, by crushing the mixture, which had undergone the firing, in a mill (a jet mill), the mixture was crushed to a predetermined particle diameter (crushing 2).
The positive electrode active material of Example 1, which contained particles of compound A and particles of compound B, was thereby obtained.

### Examples 2 Through 4

Positive electrode active materials of respective Examples were obtained in the same way as in Example 1, except that the ratios of the element M (Ti) and the 0 in the particles of compound B in Example 1 were adjusted so as to be the ratios shown in Table 1.

### Examples 5 Through 9

Positive electrode active materials of respective Examples were obtained in the same way as in Example 1, except that the M raw material of Example 1 was changed from TiO₂ to ZrO₂ (Example 5), Ta₂O₅ (Example 6), Pr₂O₃ (Example 7), La₂O₃ (Example 8) and K₂O (Example 9).

### Comparative Example 1

### (Synthesizing of Positive Electrode Active Material)

A positive electrode active material having particles of compound A, which had a composition represented by LiₓNiₐCo_{b}Mn_{c}O_{y} and in which x, a, b, c and y were in the ratio listed in Table 1, was synthesized by the method described hereinafter.

The positive electrode active material of Comparative Example 1 was obtained in the same way as in Example 1, except that the step of “Mixing of M Raw Material” and the step of “Firing 2 and Crushing 2” of Example 1 were not carried out.

### Comparative Example 2

### (Synthesizing of Positive Electrode Active Material)

A positive electrode active material having particles of compound A, which had a composition represented by LiₓNiₐCo_{b}Mn_{c}O_{y} and in which x, a, b, c and y were in the ratio listed in Table 1 and in which the element listed in Table 1 was used as the element represented by M, was synthesized by the method described hereinafter.

### Raw Material Solution

NiSO₄, CoSO₄ and MnSO₄ were dissolved in ion-exchanged water, and a raw material solution was obtained. The ratio of the Ni/Co/Mn was 1/1/1 (atm %), and the concentration of the aqueous solution was made to be 30 mass %.

### Crystallization

A given amount of an NH₃ aqueous solution was placed in a reaction vessel, and nitrogen substitution was carried out while stirring by a stirrer. NaOH was added into the reaction vessel, and the pH was made alkaline. Next, the raw material solution and NH₃ were added in drops while controlling the reaction vessel interior to a constant pH (a pH of 10˜12), and a transition metal hydroxide was precipitated.

### Rinsing, Filtering, Drying

The precipitated transition metal hydroxide was removed by filtering. Ion-exchanged water was added thereto and dispersed by stirring by a spoon, so as to carry out rinsing.
Next, the liquid used in the rinsing was filtered, and the transition metal hydroxide was removed.
Then, the filtered-out transition metal hydroxide was dried for 16 hours at 120° C., and the moisture was evaporated.

### Mixing of Li Raw Materials and M Raw Material

The dried transition metal hydroxide, and Li₂CO₃ and LiOH serving as Li raw materials, and TiO₂ serving as an M raw material, were mixed together in a mortar.

### Firing 1 and Crushing 1

The mixture of the transition metal hydroxide and the Li raw materials was fired for 10 hours in a firing furnace (muffle furnace) at 800° C. in an oxygen atmosphere (firing 1). Then, by crushing the mixture, which had undergone the firing, in a mill (a jet mill), the mixture was crushed to a predetermined particle diameter (crushing 1).
The positive electrode active material of Comparative Example 2, which contained particles of compound A, was thereby obtained.

### [Measuring of Specific Element an Amount (mol %) and Surface Area Proportion (Surface Area %) of Particles of Compound B]

The amount of an element (specific element) having an ion radius α of 0.60 Å≤α≤1.38 Å in the particles of compound B, and the surface area proportion X of the particles at which the amount of the specific element was greater than or equal to 45 mol % (i.e., the particles of compound B), with respect to the total of the particles of compound A and the particles of compound B, in the positive electrode active materials obtained in Examples 1 through 9 were measured by the following methods.

First, data was acquired by an SEM such that 10 particles of the positive electrode active material were included therein, and this was repeated until data of 100 particles could be acquired. Next, by quantitative analysis of the composition by EDX, a circular analysis region that ran along the outer periphery of each particle was set and acquired. The amount of the element (the specific element), having an ion radius α of 0.60 Å≤α≤1.38 Å, in the particles of compound B was determined by the EDX quantitative analysis of the composition. The results thereof are shown in Table 1.

Further, the surface area proportion (surface area %) of the particles (i.e., the particles of compound B), at which the amount of the element having an ion radius of 0.60 Å˜1.38 Å (the specific element) was greater than or equal to 45 mol %, was derived from the data of the circular analysis regions that were set along the outer peripheries of the respective particles.

### Manufacturing of Cells

Cells were manufactured by using the positive electrode active materials of the respective Examples and the respective Comparative Examples.
Cell Structure
   wound cylinder
   positive electrode composition: positive electrode active material/acetylene black (conductive material)/polyvinylidene fluoride=88/10/2 (mass %)
   negative electrode composition: natural graphite/styrene-butadiene rubber (SBR)/carboxymethylcellulose (CMC)
   electrolyte liquid composition: electrolyte=LiPF₆ (1M), solvent=ethylene carbonate (EC)/dimethyl carbonate (DMC)/ethyl methyl carbonate (EMC)=3/4/3 (vol %)

### Manufacturing of Electrodes

A positive electrode and a negative electrode were coated onto collectors by a film applicator equipped with a film thickness adjusting function (Allgood Co., Ltd.), and drying was carried out for 5 minutes at 80° C. in a drier, and a cell was thereby manufactured.

### Measuring of Initial Battery Resistance

The initial battery resistances of the cells obtained in the respective Examples and Comparative Examples were measured. The results of the proportion (%) of the battery resistance of each Example and Comparative Example, with the battery resistance of Comparative Example 1 being “100%”, are shown in Table 1.

TABLE 1

| | | | | | | | | compound B | | | | |
|---|---|---|---|---|---|---|---|---|---|---|---|---|
| | compound A | | | | | | | M | | | | amount of |
| | Li | Ni | Co | Mn | O | M | | | ion | | | specific |
| | ratio | ratio | ratio | ratio | ratio | | ratio | | diameter | ratio | ratio | element |
| | x | a | b | c | y | type | d | type | (Å) | d | e | (mol %) |
| Comp. | 1.1 | 0.8 | 0.1 | 0.1 | 2.0 | — | — | — | — | — | — | — |
| Ex. 1 | | | | | | | | | | | | |
| Comp. | | | | | | Ti | 0.05 | — | — | — | — | — |
| Ex. 2 | | | | | | | | | | | | |
| Ex. 1 | | | | | | — | 0 | Ti | 0.61 | 0.01 | 0.02 | 59.8 |
| Ex. 2 | | | | | | — | 0 | Ti | 0.61 | 0.05 | 0.1 | 59.8 |
| Ex. 3 | | | | | | — | 0 | Ti | 0.61 | 0.1 | 0.2 | 59.8 |
| Ex. 4 | | | | | | — | 0 | Ti | 0.61 | 0.2 | 0.4 | 59.8 |
| Ex. 5 | | | | | | — | 0 | Zr | 0.72 | 0.05 | 0.1 | 74.0 |
| Ex. 6 | | | | | | — | 0 | Ta | 0.64 | 0.05 | 0.13 | 76.6 |
| Ex. 7 | | | | | | — | 0 | Pr | 0.85 | 0.05 | 0.08 | 85.4 |
| Ex. 8 | | | | | | — | 0 | La | 1.03 | 0.05 | 0.08 | 85.3 |
| Ex. 9 | | | | | | — | 0 | K | 1.38 | 0.05 | 0.03 | 83.0 |

| | compound B | | | temperature | temperature | |
|---|---|---|---|---|---|---|
| | | surface | | of | of | |
| | | area | synthe- | first | second | initial |
| | assumed | proportion | sizing | firing | firing | resistance |
| | compound | (%) | method | (° C.) | (° C.) | (%) |
| Comp. | — | 0 | — | 800 | — | 100 |
| Ex. 1 | | | | | | |
| Comp. | — | 0 | 1 | 800 | — | 101 |
| Ex. 2 | | | | | | |
| Ex. 1 | TiO₂ | 0.8 | 2 | 800 | 400 | 95 |
| Ex. 2 | TiO₂ | 4.8 | 2 | 800 | 400 | 85 |
| Ex. 3 | TiO₂ | 8.9 | 2 | 800 | 400 | 75 |
| Ex. 4 | TiO₂ | 19.6 | 2 | 800 | 400 | 70 |
| Ex. 5 | ZrO₂ | 4.6 | 2 | 800 | 400 | 88 |
| Ex. 6 | Ta₂O₅ | 4.2 | 2 | 800 | 400 | 91 |
| Ex. 7 | Pr₂O₃ | 4.5 | 2 | 800 | 400 | 95 |
| Ex. 8 | La₂O₃ | 4.3 | 2 | 800 | 400 | 92 |
| Ex. 9 | K₂O | 4.4 | 2 | 800 | 400 | 86 |

It can be understood that, as shown in Table 1, the positive electrode active materials of the respective Examples that contained particles of compound B, in which the amount of an element having an ion radius α of 0.60 Å≤α≤1.38 Å was greater than or equal to 45 mol %, in a range of a surface area proportion of greater than or equal to 0.8% and less than or equal to 19.6%, with respect to the total of the particles of compound A and the particles of compound B, could reduce the initial battery resistance as compared with the positive electrode active materials of the respective Comparative Examples that did not contain particles of compound B.

The invention claimed is:

1. A positive electrode active material comprising particles of compound A having a composition represented by LiₓNiₐCo_{b}Mn_{c}O_{y}, and particles of compound B having a composition represented by M_{d}Oₑ, wherein:
in the particles of compound B, an amount of an element having an ion radius α of 0.60 Å≤α≤1.38 Å is greater than or equal to 45 mol %,
surface area proportion X of the particles of compound B, with respect to a total of the particles of compound A and the particles of compound B, is 0.8%≤X≤19.6%, and
in the composition of compound A, 0.1≤x≤1.5, 0.5≤a≤1.0, 0≤b≤0.3, 0≤c≤0.3, a+b+c=1.0 and 1.5≤y≤2.1, and, in the composition of compound B, 0.001≤d≤0.2 and 0.002≤e≤0.4, and M represents at least one element selected from the group consisting of Ti, Zr, Ta, Pr, K, La, Ba, Y, Sr, Ce, Se, Hf and Rh.

2. The positive electrode active material of claim 1, wherein the element represented by M is at least one element selected from the group consisting of Ti, Zr, Ta, Pr, K and La.

3. The positive electrode active material of claim 2, wherein the element represented by M is Ti.

4. A battery comprising the positive electrode active material of claim 1.

5. A method of manufacturing a positive electrode active material, comprising:
preparing a solution in which are dissolved raw materials containing Ni, Co and Mn, respectively;
adding the solution to an alkaline solution, and precipitating a hydroxide;
collecting a precipitate from the alkaline solution;
mixing the precipitate, and a raw material that contains Li, and obtaining a first mixture;
firing the first mixture;
mixing a raw material, which contains an element represented by M, with the first mixture that has undergone firing, and obtaining a second mixture; and
firing the second mixture,
wherein M represents at least one element selected from the group consisting of Ti, Zr, Ta, Pr, K, La, Ba, Y, Sr, Ce, Se, Hf and Rh.

6. A battery comprising the positive electrode active material of claim 2.

7. A battery comprising the positive electrode active material of claim 3.
